(19) United States
(12) Patent Application Publication
(10) Pub. No.: US 2010/0205254 A1
(43) Pub. Date: Aug. 12, 2010

(54) METHOD AND SYSTEM OF TRACKING CONTENT IN A SOCIAL NETWORK

(75) Inventor: Kevin Ham, Vancouver (CA)

Correspondence Address: Nixon Peabody LLP, P.O. Box 60610, Palo Alto, CA, 94306, US

(73) Assignee: Reinvent, Inc., Vancouver (CA)

(21) Appl. No.: 12/367,476

(22) Filed: Feb. 6, 2009

(51) Int. Cl. G06F 15/16; G06F 15/173; G06Q 99/00

(52) U.S. Cl. 709/206; 709/224; 705/319

(57) ABSTRACT

The system and method according to the invention allows users of a social network to determine the geographical dissemination of content within the network and the speed with which the content is disseminated and the extent of the dissemination, both in geographic terms and number of users experiencing the content. The dissemination is tracked by determining the number and location of other users to whom a user sends the content, and that experience the content. The geographic location of the recipient is determined using the IP address of the recipient or the geographic location provided. The impact of a particular user on the dissemination of the content can result in the awarding of points for the user. The invention also allows the impact of a particular user in disseminating a particular piece of content to be measured and ranked.

### FIELD OF THE INVENTION

This invention relates to social networks, and more particularly to methods and systems for tracking the dissemination of content provided by different users within a social network.

### BACKGROUND OF THE INVENTION

There are many web sites that provide social networking. Social networking web sites allow users of the web site to post content to the web site, such as images, text, audio, video, etc. for experiencing by others. On many of these sites, the content can be experienced by all visitors to the web site, or the content may only be available to those users who have been invited to access the content by the poster (often referred to as “friends” or “contacts”).

A difficulty with these web sites is that once content is made accessible to other users of the web site, it is difficult to determine how that content is disseminated amongst other users. From an administrator's standpoint, it may be valuable to know who distributes the content, i.e. which users are responsible for disseminating the content to other users, and therefore, which users have the most “influence” in the dissemination of the content.

An example of a web site that allows users to encourage the dissemination of content is Digg.com, which allows users to provide support for various Internet based content, by including an option whereby a user can “Dig” the content by clicking on the appropriate icon associated with the content. When the Dig icon is clicked the counter of “Digs” is incremented by one and the content with the most “Digs” within a specific time frame is listed with a link to the content at the website digg.com.

### SUMMARY OF THE INVENTION

The invention provides a means to track the spread of content within or from a social network to determine the speed with which the content is disseminated and the extent of the dissemination (both in geographic terms and number of users experiencing the content). The content, be it text, photo, audio, video or another form may be disseminated via a social network of users on the Internet, mobile phone or email. A user will be able to determine how fast the content is spreading and how far the content is spreading, but will also be able to observe how the user has been responsible for the spread of the content. The user's impact on the dissemination of the content will result in the awarding of points for the user, which may be redeemable for goods or services.

The invention also provides a means of measuring the impact of a particular user in disseminating a particular piece of content. The point system may be used to provide a value indicating the user's impact.

The invention also provides a means to rank users, using the points awarded, in their ability to disseminate content within a social network.

A method of a providing content to a plurality of contacts is provided, including a) uploading, by a user, a piece of content to a web page accessible to the plurality of contacts; b) transmitting a message to a subset of the plurality of contacts, the contacts in the subset selected by the user, the message containing a link to the content; c) for each of the contacts in the subset that experiences the content, determining a geographic location of the contact; and d) determining the geographic reach of the content via the geographic locations of the contacts in the subset that experience the content.

The user may view a display showing the geographical reach of contacts experiencing the content. The geographical location of the contacts may be determined by registration information provided by at least one of the contacts. The geographical location of the contacts may be determined by the IP address of at least one of the contacts. The contacts experiencing the content may be invited to provide a message to a plurality of recipients within a contact database of the contact.

A system for providing content to a plurality of contacts of a user is provided, including: a web site accessible to the user, the web site storing an email address of each of the plurality of contacts, the web site receiving the content from the user, wherein the web site prompts the user to send a message to the plurality of contacts regarding the content, and the user may view the geographic reach of said content as determined by the system.

The web site may display the geographical reach of contacts experiencing the content. The geographical location of the contacts may be determined by registration information provided by at least one of the contacts. The geographical location of the contacts may be determined by the IP address of at least one of the contacts. Each of the contacts experiencing the content may be invited to provide a message to a plurality of recipients within a contact database of the contact.

A method for a user to disseminate content to a plurality of contacts is provided, including: a) uploading a piece of content to a web page accessible to the plurality of contacts; b) categorizing and rating the content; c) selecting a subset of the plurality of contacts to receive a message containing a link to the content; and d) viewing the geographic location of the contacts that experience the content at the web site.

The geographical location of the contacts may be determined by registration information provided by at least one of the contacts. The geographical location of the contacts may be determined by the IP address of at least one of the contacts. Each of the contacts experiencing the content may be invited to provide a message to a plurality of recipients within a contact database of the contact. Contacts that experience the content may rate the content. The user may be awarded points on one of the contacts experiencing the content.

### DETAILED DESCRIPTION OF THE FIGURES

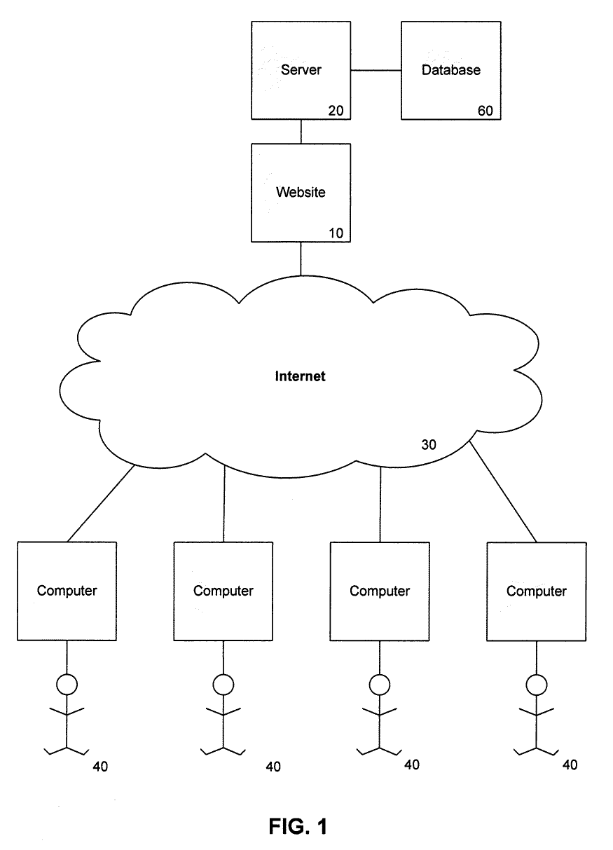

FIG. 1 is a block diagram of a system according to an embodiment of the invention;

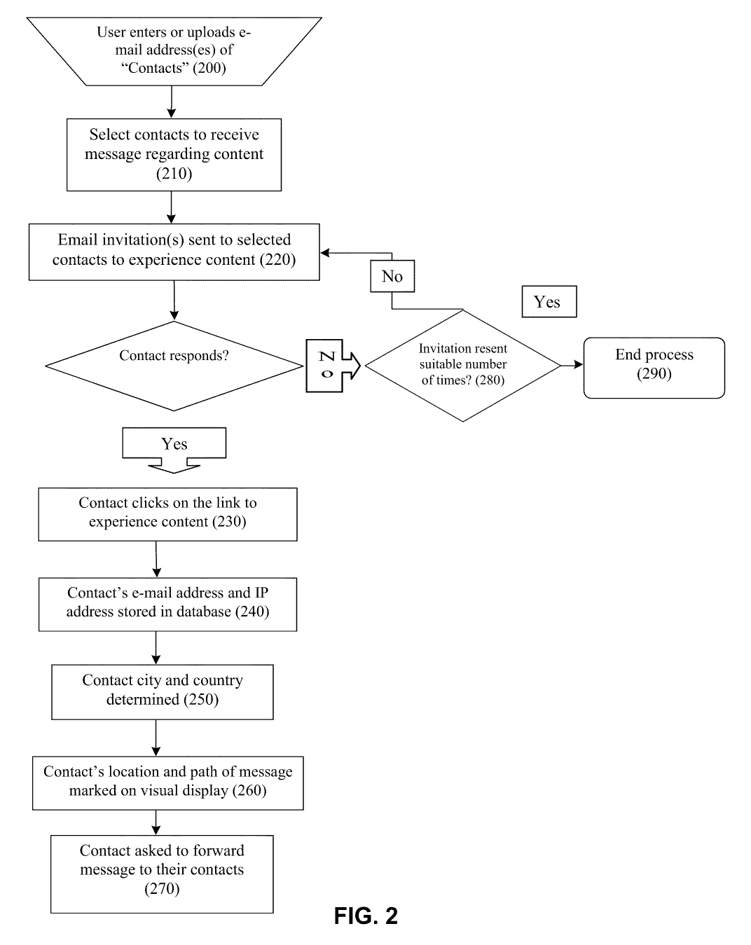

FIG. 2 is a flow chart showing the dissemination of content according to an embodiment of the invention;

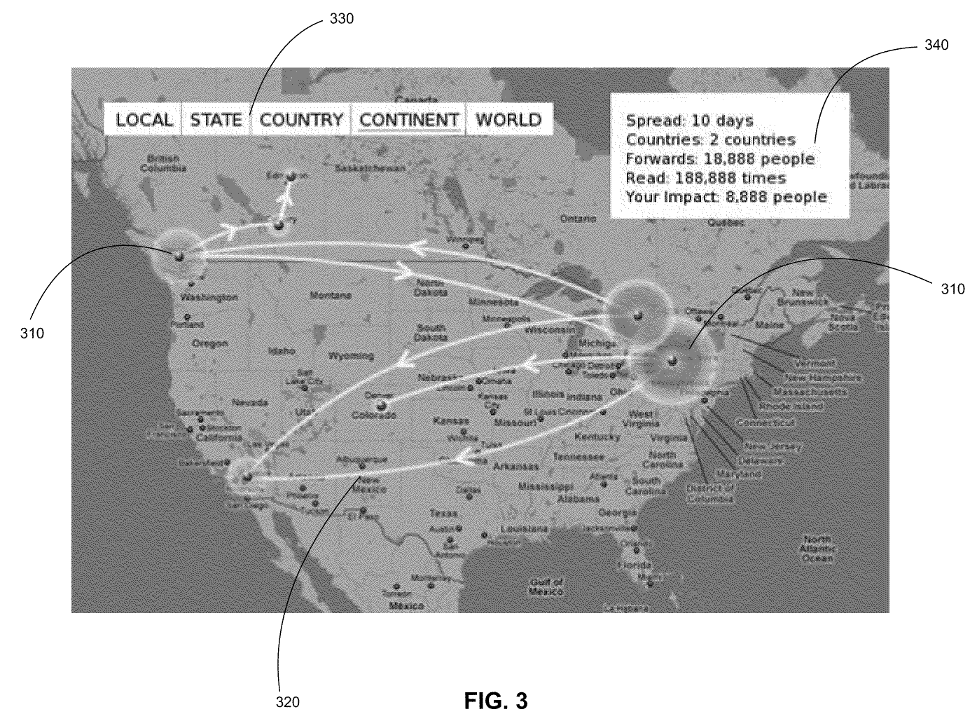

FIG. 3 is a representation of an image showing the geographical dissemination of content according to an embodiment of the invention; and

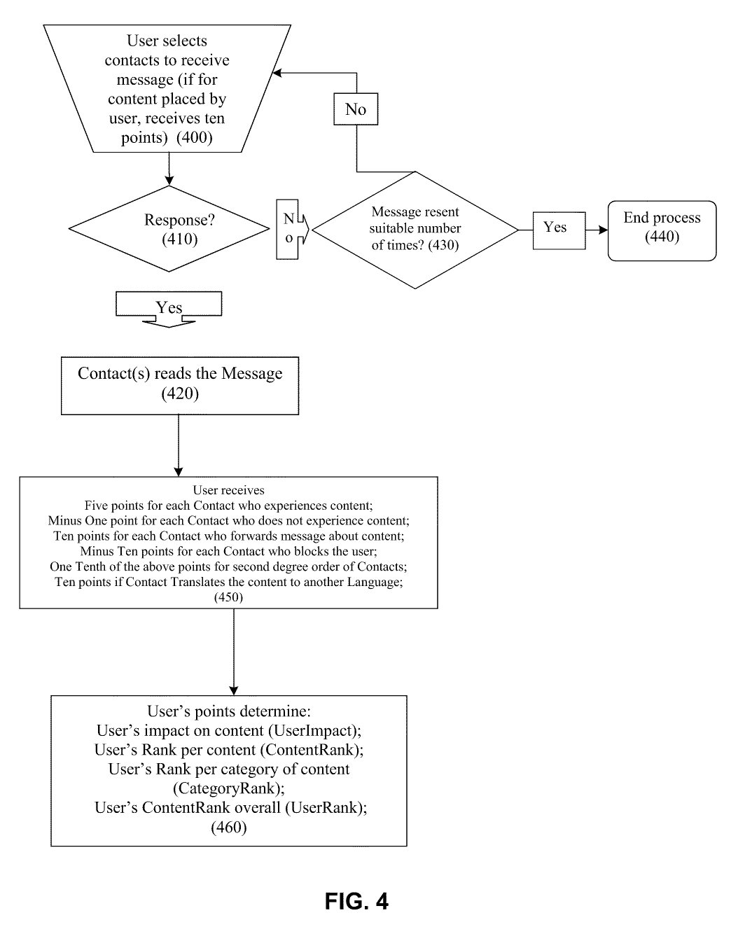

FIG. 4 is a flow chart showing the awarding of points to users according to an embodiment of the invention.

### DETAILED DESCRIPTION OF THE INVENTION

The following discussion provides a brief and general description of a suitable computing environment in which various embodiments of the system may be implemented. Although not required, embodiments will be described in the general context of computer-executable instructions, such as program applications, modules, objects or macros being executed by a computer. Those skilled in the relevant art will appreciate that the invention can be practiced with other computer configurations, including hand-held devices, multiprocessor systems, microprocessor-based or programmable consumer electronics, personal computers (“PCs”), network PCs, mini-computers, mainframe computers, and the like. The embodiments can be practiced in distributed computing environments where tasks or modules are performed by remote processing devices, which are linked through a communications network. In a distributed computing environment, program modules may be located in both local and remote memory storage devices.

A computer system may be used as a server including one or more processing units, system memories, and system buses that couple various system components including system memory to a processing unit. Computers will at times be referred to in the singular herein, but this is not intended to limit the application to a single computing system since in typical embodiments, there will be more than one computing system or other device involved. Other computer systems may be employed, such as conventional and personal computers, where the size or scale of the system allows. The processing unit may be any logic processing unit, such as one or more central processing units (“CPUs”), digital signal processors (“DSPs”), application-specific integrated circuits (“ASICs”), etc. Unless described otherwise, the construction and operation of the various components are of conventional design. As a result, such components need not be described in further detail herein, as they will be understood by those skilled in the relevant art.

A computer system includes a bus, and can employ any known bus structures or architectures, including a memory bus with memory controller, a peripheral bus, and a local bus. The computer system memory may include read-only memory (“ROM”) and random access memory (“RAM”). A basic input/output system (“BIOS”), which can form part of the ROM, contains basic routines that help transfer information between elements within the computing system, such as during startup.

The computer system also includes non-volatile memory. The non-volatile memory may take a variety of forms, for example a hard disk drive for reading from and writing to a hard disk, and an optical disk drive and a magnetic disk drive for reading from and writing to removable optical disks and magnetic disks, respectively. The optical disk can be a CD-ROM, while the magnetic disk can be a magnetic floppy disk or diskette. The hard disk drive, optical disk drive and magnetic disk drive communicate with the processing unit via the system bus. The hard disk drive, optical disk drive and magnetic disk drive may include appropriate interfaces or controllers coupled between such drives and the system bus, as is known by those skilled in the relevant art. The drives, and their associated computer-readable media, provide non-volatile storage of computer readable instructions, data structures, program modules and other data for the computing system. Although a computing system may employ hard disks, optical disks and/or magnetic disks, those skilled in the relevant art will appreciate that other types of non-volatile computer-readable media that can store data accessible by a computer system may be employed, such a magnetic cassettes, flash memory cards, digital video disks (“DVD”), Bernoulli cartridges, RAMs, ROMs, smart cards, etc.

Various program modules or application programs and/or data can be stored in the computer memory. For example, the system memory may store an operating system, end user application interfaces, server applications, and one or more application program interfaces (“APIs”).

The computer system memory also includes one or more networking applications, for example a Web server application and/or Web client or browser application for permitting the computer to exchange data with sources via the Internet, corporate Intranets, or other networks as described below, as well as with other server applications on server computers such as those further discussed below. The networking application in the preferred embodiment is markup language based, such as hypertext markup language (“HTML”), extensible markup language (“XML”) or wireless markup language (“WML”), and operates with markup languages that use syntactically delimited characters added to the data of a document to represent the structure of the document. A number of Web server applications and Web client or browser applications are commercially available, such those available from Mozilla and Microsoft.

The operating system and various applications/modules and/or data can be stored on the hard disk of the hard disk drive, the optical disk of the optical disk drive and/or the magnetic disk of the magnetic disk drive.

A computer system can operate in a networked environment using logical connections to one or more client computers and/or one or more database systems, such as one or more remote computers or networks. A computer may be logically connected to one or more client computers and/or database systems under any known method of permitting computers to communicate, for example through a network such as a local area network (“LAN”) and/or a wide area network (“WAN”) including, for example, the Internet. Such networking environments are well known including wired and wireless enterprise-wide computer networks, intranets, extranets, and the Internet. Other embodiments include other types of communication networks such as telecommunications networks, cellular networks, paging networks, and other mobile networks. The information sent or received via the communications channel may, or may not be encrypted. When used in a LAN networking environment, a computer is connected to the LAN through an adapter or network interface card (communicatively linked to the system bus). When used in a WAN networking environment, a computer may include an interface and modem or other device, such as a network interface card, for establishing communications over the WAN/Internet.

In a networked environment, program modules, application programs, or data, or portions thereof, can be stored in a computer for provision to the networked computers. In one embodiment, the computer is communicatively linked through a network with TCP/IP middle layer network protocols; however, other similar network protocol layers are used in other embodiments, such as user datagram protocol (“UDP”). Those skilled in the relevant art will readily recognize that these network connections are only some examples of establishing communications links between computers, and other links may be used, including wireless links.

While in most instances a computer will operate automatically, where an end user application interface is provided, a user can enter commands and information into the computer through a user application interface including input devices, such as a keyboard, and a pointing device, such as a mouse. Other input devices can include a microphone, joystick, scanner, etc. These and other input devices are connected to the processing unit through the user application interface, such as a serial port interface that couples to the system bus, although other interfaces, such as a parallel port, a game port, or a wireless interface, or a universal serial bus (“USB”) can be used. A monitor or other display device is coupled to the bus via a video interface, such as a video adapter (not shown). The computer can include other output devices, such as speakers, printers, etc.

As seen in FIG. 1, the system and method according to the invention are for use with a web site 10 operated on a server 20, accessible over the Internet 30 by users 40, using computer systems 50, who may post content on web site 10 and have an ability to view content posted on the web site 10 by other users 40.

The web site 10 is a collection of web pages, hosted on one or more servers 20. Users 40 typically connect to web site 10 on the Internet using hyperlinks, also referred to as links. By clicking on a link, a user 10 directs a browser operating on computer system 50 to open a window on the monitor of the computer system 50 showing the web site associated with the link.

Typically users 40 must register with web site 10 to contribute content to web site 10. Such a registration system may include obtaining information about the user 40 such as their name, email address, geographic information, such as address, or country of residence, and the like (as described below). Once registered, users 40 can log on to web site 10 using a user name and password, which are provided by server 20 or selected by the user on registration. The user 40 will also be provided a personal web page at web site 10 at which they can upload and display content for other users 40.

Server 20 has database 60 which stores the web site, the content thereon, associated web pages, records about each user 40 and the content, and information about each link.

Web site 10 provides a home web page including a list of content, with links to each piece of content. Additional information associated with the content is also displayed. Such information includes the “reach” of the content. The reach of the content is based on both the number of users 40 who have clicked on the link to experience the content and the number of countries in which users 40 have experienced the content, based on either the geographic locations provided by registered users selecting the link, or by using the IP address or email address of a user 40 to determine the country of origin of the user. Other information displayed near the link to the content may be a user rating or rank of the content, a value which registered users may contribute once they have confirmed experiencing the content.

When a user 40 visits the home page, they may log in, if they are a registered user. If they are not a registered user, they will be unable to access certain features of the web site, but server 20 records the IP address of the unregistered user, and offers the unregistered user an opportunity to register.

When a user 40 registers, they obtain an account, and provide, to the system, their first name, last name, geographic location (by city or town) and birthday. The system may also request information about the device being used to access the web page, for example the type of computer, the manufacturer of the computer, the browser being used, etc. The user then selects a password and username for accessing web site 10.

The process according to the invention begins with the registered user 40 uploading content to the web site 10. The user may “tag” the content with descriptive keywords, for example an article about the election may be tagged with the word “election”. The user may also categorize the content by type (audio, video, image, text, etc.) and/or subject matter (news, joke, etc.). Typical categories may include: “Good News”, “Religious”, “Business”, “Humorous”, “Political”, etc.

As seen in FIG. 2, the user 40 can then send a message regarding the content to his or her contacts. To upload the content (i.e. in order for server 20 to store the content in database 60), the user must send a message to at least one other user, and may send the message to, at most, a predetermined maximum number of users, for example 150 users, to prevent the user “spamming” others.

In step 200, the user uploads contacts from his email program, email provider, social network or mobile telephone by either entering the contacts at the user's web page or copying the appropriate files to the web page. Contacts need only be uploaded or entered once, and are then stored as contacts in database 60 associated with that user 40. User 40 then selects which contacts to receive a message regarding the new content in step 210. The system associates the tags and type of the content with the contact to whom the message is being sent.

The selected contacts are sent an email message from the system indicating that their friend, the user, has requested that they experience content the user has uploaded (step 220). The contact can respond by clicking on the link within the message to access the content (step 230). If the contact clicks on the link, the system records such and records the email address of the contact and the IP address of the contact (step 240) to determine a location (i.e. Country, City) of the contact (step 250). The location and path of the content are then marked on a visual display (step 260).

If a user receiving the message does not respond, the message will be resent a predetermined number of times (step 280). After the messages has been sent that number of times, the system concludes that no response is likely (step 200) and terminates the process. This failure to reach the contact is stored in database 60.

The contact is then asked if they will send a message to their contacts with a link to the content if they found experiencing the content to be useful or enjoyable (step 270). If the contact indicates they would like to do so, they are prompted to register with the system if they have not already done so, and then repeat the procedure as described above. Once a message has been sent to contacts about content, a link appears next to the link to the content whereby users may click and view the geographic spread of the content visually or via a text description as seen in FIG. 3. A user can also view who, among their contacts they sent a message to, experiences the content and therefore the impact that user had in spreading the content geographically.

As seen in FIG. 3, users 40 can view the spread of a message visually. The size of the circle 310 around a location, such as a city shows the number of users in that city that have experience the content. The arrows 320 show the direction of spread from city to city. Users can choose the scale of the view by selecting from the options in the scale menu 330, such as Continent, Country, State or Province, etc. Statistical information 340 may also be displayed, showing the time frame of the “reach” of the content, the number of countries, the number of time the content has been experienced, etc.

As more content is disseminated by a user 40, both the user and the user's perception of their contacts' preferences are recorded in database 60. The system will then be in a position to determine which of a user's contacts may be interested in the content uploaded by the user by comparing the tags and type associated with the content with the records of content previously experienced by that contact. Likewise, by tracking the content uploaded by a user, the system can determine his preferences and can suggest that user to a different user for selection to receive a message for appropriate content, when that user appears as a contact.

The system, by collecting this information about content and users 40 can, with a particular piece of content, calculate the impact of a user in disseminating the content. Based on the contribution of a user (for example the number of contacts to whom messages are sent, and the geographic disparity of those contacts), the user is awarded “points” by the system which are stored in database 80 and associated with the user. Users 40 can also be given ratings by their contacts, and receive additional points for favorable ratings. Likewise a user can block messages from another user to prevent the receipt of messages from that user. Users can also provide ratings to content, and that rating may be provided within the email messages linking to that content.

Points may be rewarded for a variety of actions. For example, when a contact to whom the user has sent a message, clicks on the link and experiences the content, the user who sent the message is awarded points. If the contact sends messages to his or her own contacts about the content, then the user who originally sent the message to that contact is awarded additional points. In an embodiment of the invention a user receives points for up to six degrees of separation from a contact (i.e. more than five messages from contact to contact must have elapsed until the user will no longer receive points).

In addition, users may lose points, for example if a contact blocks messages from the user. In an embodiment of the invention, if a predetermined number of these blocks are applied to a user, the number of messages they can send to contacts may be reduced.

To incentivize users, the system may provide rewards. For example, there may be prizes rewarded each month based on the number of points received. Alternatively, points can be redeemed for goods and services. Prizes may be used to promote the system to new and prospective users.

An example of a point distribution system is shown in FIG. 4. In this case the user 40 begins by sending a message regarding content they uploaded, or sending emails to contacts about content they discovered through another user (step 400). As in the case when the user 40 is sending messages, the system determines if the selected contacts respond to the email by clicking on the provided link (410), and experiencing the content (420). If no response is received after a predetermined number of attempts (step 430), the process terminates (step 440).

The system then assesses the number of points awarded to user 40 (step 450). In the embodiment shown, the user receives five points for each contact that experiences the content; a negative point for each contact sent a message that does not experience the content with a specific time frame (for example a day); ten points for each contact that sends a message to his or her own contacts regarding the content; negative ten points for each contact that blocks messages from the user 40; 10% of the points awarded to each contact who sends messages to his or her own contacts regarding the content (this value could further be halved with each degree of separation to a new contact experiencing the content, until a maximum number of degrees of separation are reached); and ten points if a contact translates the content to another language.

The system then determines statistics about the user based on their point totals (step 460). Besides the point total, the system can determine the user's impact on dissemination of the content (the points received by that user for a particular piece of content); the user's rank amongst other users for a particular piece of content; the user's points per piece of content uploaded and the user's points per category of content (i.e. restricting the content to a particular subset).

The system may provide automated translation services to translate English content into other languages or may “target” certain countries, for example by awarding additional points for contacts experiencing the content in those countries. Also users may be awarded points if they or their contacts translate a particular piece of content.

A user can select to view content by category, so for example, when they access the home web page they are shown “Humorous” content, rather than perhaps “Political” or other categories. Users can also restrict the scope of content shown to them by the source of the content (for example they may elect to only receive content sent from within the United States).

The system may also employ an algorithm to connect users with other users of similar interests, is they tend to experience the same or similar content, and rate content in a similar fashion. The system can then suggest to one of the users that the other be added as a contact, as they will likely want to experience the same content.

The system can be used as a “viral marketing” tool to spread content rapidly throughout the world, while tracking the progress of the dissemination of the content.

There are other elements of the invention that may be present in an embodiment thereof. For example, direct email forms may be provided by the system for a user 40 to send messages to contacts about content. The system may also work as a feature within an existing social network such as Facebook™ or Myspace™.

Users may be encouraged to register with the system by being only partially able to experience the content until registering, with registration required to experience the full content.

As will be apparent to those skilled in the art, the various embodiments described above can be combined to provide further embodiments. Aspects of the present systems, methods and components can be modified, if necessary, to employ systems, methods, components and concepts to provide yet further embodiments of the invention. For example, the various methods described above may omit some acts, include other acts, and/or execute acts in a different order than set out in the illustrated embodiments.

The present methods, systems and articles also may be implemented as a computer program product that comprises a computer program mechanism embedded in a computer readable storage medium. For instance, the computer program product could contain program modules. These program modules may be stored on CD-ROM, DVD, magnetic disk storage product, flash media or any other computer readable data or program storage product. The software modules in the computer program product may also be distributed electronically, via the Internet or otherwise, by transmission of a data signal (in which the software modules are embedded) such as embodied in a carrier wave.

For instance, the foregoing detailed description has set forth various embodiments of the devices and/or processes via the use of examples. Insofar as such examples contain one or more functions and/or operations, it will be understood by those skilled in the art that each function and/or operation within such examples can be implemented, individually and/or collectively, by a wide range of hardware, software, firmware, or virtually any combination thereof. In one embodiment, the present subject matter may be implemented via ASICs. However, those skilled in the art will recognize that the embodiments disclosed herein, in whole or in part, can be equivalently implemented in standard integrated circuits, as one or more computer programs running on one or more computers (e.g., as one or more programs running on one or more computer systems), as one or more programs running on one or more controllers (e.g., microcontrollers) as one or more programs running on one or more processors (e.g., microprocessors), as firmware, or as virtually any combination thereof, and that designing the circuitry and/or writing the code for the software and or firmware would be well within the skill of one of ordinary skill in the art in light of this disclosure.

In addition, those skilled in the art will appreciate that the mechanisms taught herein are capable of being distributed as a program product in a variety of forms, and that an illustrative embodiment applies equally regardless of the particular type of signal bearing media used to actually carry out the distribution. Examples of signal bearing media include, but are not limited to, the following: recordable type media such as floppy disks, hard disk drives, CD ROMs, digital tape, flash drives and computer memory; and transmission type media such as digital and analog communication links using TDM or IP based communication links (e.g., packet links).

Further, in the methods taught herein, the various acts may be performed in a different order than that illustrated and described. Additionally, the methods can omit some acts, and/or employ additional acts.

These and other changes can be made to the present systems, methods and articles in light of the above description. In general, in the following claims, the terms used should not be construed to limit the invention to the specific embodiments disclosed in the specification and the claims, but should be construed to include all possible embodiments along with the full scope of equivalents to which such claims are entitled. Accordingly, the invention is not limited by the disclosure, but instead its scope is to be determined entirely by the following claims.

What is claimed is:

1. A method of a providing content to a plurality of contacts, comprising:
(a) uploading, by a user, a piece of content to a web page accessible to the plurality of contacts;
(b) transmitting a message to a subset of said plurality of contacts, said contacts in said subset selected by said user, said message containing a link to said content;
(c) for each of said contacts in said subset that experiences said content, determining a geographic location of said contact; and
(d) determining the geographic reach of said content via the geographic locations of said contacts in said subset that experience said content.

2. The method of claim 1 wherein said user may view a display showing the geographical reach of contacts experiencing said content.

3. The method of claim 1 wherein said geographical location of said contacts is determined by registration information provided by at least one of said contacts.

4. The method of claim 1 wherein said geographical location of said contacts is determined by the IP address of at least one of said contacts.

5. The method of claim 1 wherein each of said contacts experiencing said content is invited to provide a message to a plurality of recipients within a contact database of said contact.

6. A system for providing content to a plurality of contacts of a user, comprising:
a web site accessible to the user, said web site storing an email address of each of said plurality of contacts, said web site receiving said content from said user,
wherein said web site prompts said user to send a message to said plurality of contacts regarding said content, and
said user may view the geographic reach of said content as determined by said system.

7. The system of claim 6 wherein said web site displays the geographical reach of contacts experiencing said content.

8. The system of claim 6 wherein a geographical location of said contacts is determined by registration information provided by at least one of said contacts.

9. The system of claim 6 wherein a geographical location of said contacts is determined by the IP address of at least one of said contacts.

10. The system of claim 6 wherein each of said contacts experiencing said content is invited to provide a message to a plurality of recipients within a contact database of said contact.

11. A method for a user to disseminate content to a plurality of contacts, comprising:
(a) uploading a piece of content to a web page accessible to the plurality of contacts;
(b) categorizing and rating said content;
(c) selecting a subset of said plurality of contacts, to receive a message containing a link to said content; and
(d) viewing the geographic location of said contacts that experience said content at said web site.

12. The method of claim 11 wherein a geographical location of said contacts is determined by registration information provided by at least one of said contacts.

13. The method of claim 11 wherein a geographical location of said contacts is determined by the IP address of at least one of said contacts.

14. The method of claim 11 wherein each of said contacts experiencing said content is invited to provide a message to a plurality of recipients within a contact database of said contact.

15. The method of claim 11 wherein said contacts that experience said content may rate said content.

16. The method of claim 11 wherein said user is awarded points on one of said contacts experiencing said content.
